(19) United States
(12) Patent Application Publication
(10) Pub. No.: US 2019/0172291 A1
(43) Pub. Date: Jun. 6, 2019

(54) AUTOMATED STOCKROOM FOR SERVICE MANAGEMENT, DISPENSING & ASSET CONTROL

(71) Applicant: Black Hills Solutions, Danville, CA (US)

(72) Inventor: Jonathan Naseath, Box Elder, SD (US)

(21) Appl. No.: 16/209,208

(22) Filed: Dec. 4, 2018

Related U.S. Application Data
(60) Provisional application No. 62/594,455, filed on Dec. 4, 2017.

(51) Int. Cl. G07C 9/00; G06Q 10/10

(52) U.S. Cl. CPC G07C 9/00912; G06Q 10/105

(57) ABSTRACT

Systems and methods are discussed to dispense and manage assets throughout an assets management system. Some embodiments include a methods and systems that receive an employee ID from an employee ID card associated with an employee via the card reader; determine one or more approved assets held within one or more of the plurality of lockers that are available to be dispensed to the employee; provide a listing of the one or more approved assets held within the plurality of lockers via the user interface; receive an indication from a user via the user interface specifying a specific asset of the one or more approved assets; determine a specific locker of the plurality of lockers where the specific asset is located; and dispense the specific asset stored within specific locker by unlocking the one or more electromechanical lock associated with the specific locker.

### CROSS-REFERENCES TO RELATED APPLICATIONS

This application claims the benefit of U.S. Provisional Patent Application No. 62/594,455 filed Dec. 4, 2017, and titled “Automated Stockroom for Service Management, Dispensing & Asset Control,” which is entirely incorporated in this document by reference for all purposes

### SUMMARY

Systems and methods are discussed to dispense and manage assets throughout an asset management system. Some embodiments include methods and systems that receive an employee ID from an employee ID card associated with an employee via the card reader; determine one or more approved assets held within one or more of the plurality of lockers that are available to be dispensed to the employee; provide a listing of the one or more approved assets held within the plurality of lockers via the user interface; receive an indication from a user via the user interface specifying a specific asset of the one or more approved assets; determine a specific locker of the plurality of lockers where the specific asset is located; and dispense the specific asset stored within specific locker by unlocking the one or more electromechanical lock associated with the specific locker.

Some embodiments include an asset dispensing kiosk comprising: a plurality of lockers having electromechanical locks; a user interface; a card reader configured to read employee ID cards; and a kiosk controller communicatively coupled with the plurality of lockers, the user interface, and the card reader. In some embodiments, the kiosk controller is configured to: receive an employee ID from an employee ID card associated with an employee via the card reader; determine one or more approved assets held within one or more of the plurality of lockers that are available to be dispensed to the employee; provide a listing of the one or more approved assets held within the plurality of lockers via the user interface; receive an indication from a user via the user interface specifying a specific asset of the one or more approved assets; determine a specific locker of the plurality of lockers where the specific asset is located; and dispense the specific asset stored within specific locker by unlocking the one or more electromechanical lock associated with the specific locker.

In some embodiments, each of the plurality of lockers includes a USB connection.

In some embodiments, the kiosk controller is further configured to authenticate the employee associated with the employee Id.

In some embodiments, the asset dispensing kiosk may comprise a code reader configured to read visual code displayed on an asset, wherein the kiosk controller is further configured to: read a code on the specific asset; and confirm that the specific asset was the proper asset to be dispensed.

In some embodiments, the asset dispensing kiosk may comprise a code reader configured to read visual code displayed on an asset, wherein the kiosk controller is further configured to: read a code on the specific asset; and record in a database that the employee associated with the employee ID received the specific asset including the code on the specific asset and the employee ID.

In some embodiments, the asset dispensing kiosk may comprise a communication interface, wherein the kiosk controller is further configured to: send the employee ID to a remote server via the communication interface; and receive a listing of approved one or more approved assets from the remote server.

In some embodiments, each of the plurality of lockers includes a sensor that can detect the presence or absence of an asset within the locker, and wherein the kiosk controller can receive a signal from each sensor indicating whether an asset is located within corresponding locker.

In some embodiments, the asset dispensing kiosk may comprise a digital camera that records an interaction with a user.

In some embodiments, the asset dispensing kiosk may comprise a digital camera, wherein the kiosk controller is further configured to: receive a digital image from the digital camera; and perform facial recognition on the digital image.

In some embodiments, the asset dispensing kiosk may comprise a VR interface that communicates with a user.

Some embodiments include a method for operating an asset dispensing kiosk comprising: receiving an employee ID from an employee ID card associated with an employee, the employee ID being received via a card reader; determining one or more approved assets held within one or more of a plurality of lockers associated with a kiosk that are available to be dispensed to the employee; providing a listing of the one or more approved assets held within the plurality of lockers via a user interface; receiving an indication from a user via the user interface specifying a specific asset of the one or more approved assets; determining a specific locker of the plurality of lockers where the specific asset is located; and dispensing the specific asset stored within specific locker by unlocking the specific locker.

In some embodiments, the method further comprises authenticating the employee associated with the employee Id.

In some embodiments, the method further comprises reading a code on the specific asset after the asset has been dispensed using a code reader; and confirming that the specific asset was the proper asset to be dispensed

In some embodiments, the method further comprises sending the employee ID to a remote server via a communication interface; and receiving a listing of approved one or more approved assets from the remote server

In some embodiments, the method further comprises reading a code on the specific asset after the asset has been dispensed using a code reader; and recording in a database that the employee associated with the employee ID received the specific asset including the code on the specific asset and the employee ID.

Some embodiments include an asset dispensing kiosk comprising: a dispensing subsystem having electromechanical locks; a user interface; a card reader configured to read employee ID cards; and a kiosk controller communicatively coupled with the dispensing subsystem, the user interface, and the card reader. In some embodiments, the kiosk controller is configured to: receive an user ID from an user ID card associated with an user via the card reader; determine one or more approved assets that are available to be dispensed to the user; provide a listing of the one or more approved assets to the user via the user interface; receive an indication from a user via the user interface specifying a specific asset of the one or more approved assets; determine whether the specific asset is available to be dispensed via the dispensing subsystem; and in the event the specific asset is not currently available to be dispensed via the dispensing subsystem, send a request to a cloud server requesting delivery of the specific asset.

In some embodiments, the kiosk controller is further configured to: in the event the specific asset is available to be dispensed via the dispensing subsystem, dispense the specific asset via the dispensing subsystem.

In some embodiments, the kiosk controller is further configured to: receive an indication that the specific asset has been loaded within the dispensing subsystem; receive an indication via the user interface and/or the card reader that the user is ready to retrieve the specific asset; and dispense the specific asset via the dispensing subsystem.

In some embodiments, the dispensing subsystem includes a plurality of lockers that include a USB connection.

In some embodiments, the asset dispensing kiosk may comprise a code reader configured to read visual code displayed on an asset, wherein the kiosk controller is further configured to: read a code on the specific asset; and confirm that the specific asset was the proper asset to be dispensed.

These illustrative embodiments are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying drawings.

FIG. 1 is a block diagram of an automated stockroom system according to some embodiments.

FIG. 2 is a block diagram of a kiosk according to some embodiments.

FIG. 3 is a flowchart of a process for receiving an asset according to some embodiments.

FIG. 4 is a flowchart of a process for receiving and dispensing an asset according to some embodiments.

FIG. 5 is a flowchart of a process for dispensing an asset according to some embodiments.

FIG. 6 shows an illustrative computational system for performing functionality to facilitate implementation of embodiments described herein.

FIG. 7 is a flowchart of a process for dispensing shift asset(s) according to some embodiments.

### DETAILED DESCRIPTION

Systems and methods related to an automate stockroom system are disclosed. In some embodiments, an automated stockroom system may include a plurality of kiosks in communication with a kiosk management system. In some embodiments, an automated stockroom system may automate stockroom and helpdesk check-in & check-out. In some embodiments, an automated stockroom system may scan badges and/or barcodes and/or capture employee data and/or asset data with physical positive control compliance. In some embodiments, an automated stockroom system may provide real time asset procurement convenience to end-users. In some embodiments, an automated stockroom system may funnel employee device purchases through approved channels and/or catalogs. In some embodiments, an automated stockroom system may provide fun employee experience interactive virtual reality assistant

Some embodiments include an automated stockroom for controlling assets, equipment and/or consumables that may need to be distributed to employees or authorized personnel and/or collected from authorized personnel. The term “asset” as used throughout this document may include devices, electronic equipment, tools, consumables, phones, peripherals, handheld equipment, accessories, ink cartridges, batteries, cables, cords, cameras, tablets, laptops, memory devices, cameras, etc. The term “device” may be used as a synonym for the term “asset” and may include electronic equipment, tools, consumables, phones, peripherals, handheld equipment, accessories, ink cartridges, batteries, cables, cords, cameras, tablets, laptops, memory devices, cameras, etc. In some embodiments, an automated stockroom may include a user interface that may display a catalog or listing of items available through the stockroom or in nearby stockrooms. In some embodiments, an automated stockroom can collect user identification information through a badge reader, RFID or user login and/or verify authorization for distribution. In some embodiments, an automated stockroom may include a method for dispensing items through either an automated locker that opens after authorization is obtained by the system, or that dispenses the authorized item through a robotic dispensing system from bins.

In some embodiments, an automated stockroom may include a physical interface for an enterprise service management system that includes ticketing, asset tracking, consumable tracking per user, authorization, purchasing, workflows, and/or requests for items and configuration details. In some embodiments, an automated stockroom may include a virtual artificial intelligence personality that can help users navigate their requests with the system and/or complete their orders.

In some embodiments, an automated stockroom may access and/or be integrated with any enterprise system to provide a virtual VR subsystem that can present a lifelike experience for the employee. In some embodiments, this can provide a physical interaction that can automatically collect broken assets into lockers with verified control through electronic and/or camera sensors (e.g., camera 250), and/or it can provide loaner items to users while their assets are being repaired. In some embodiments, an automated stockroom may enable users who require a device for their daily job to check-out the device at the beginning of their shift and return the item when their work is done. In some embodiments, the stored device can be recharged with power and/or the software on the device may be updated through software patches.

Some embodiments may enable check-in, check-out, dispensing, charging, and/or controlled distribution for devices on the Internet of Things, equipment, user devices, peripherals, consumables, mobile phones, computers, displays, tablets, memory sticks, and other assets, etc. Some embodiments may include a sequence of product components that can be used together to meet a company's use-case requirements. Some embodiments may provide a complete end-to-end solution which helps companies manage their internal resources for the following example activities: Turn-In Device for Repair & Checkout Loaner, Check-in & Check-out Devices for Shift of work, IT Peripheral and Consumables Dispensing, Voice Interactive Help Desk Ticket Support on a kiosk connected to the service management system, Virtual Personality Persona used on a kiosk to interact with Enterprise Service Management System.

In some embodiments, a replenishment third-party courier service provider can access and replenish a kiosk. In some embodiments, a kiosk can control and manage the solution remotely.

Some embodiments may allow a user to turn in a broken device for repair and checkout a loaner device. For example, an employee or authorized person with a badge can walk up to a kiosk, swipe their badge for authentication, turn in a broken device for repair, and/or checkout a new loaner device that is already configured and ready for their use. This self-service solution allows the employee to complete their service ticket. In some embodiments, a previously created helpdesk ticket can be created online, through a call center, or on the kiosk.

Some embodiments provide positive control for checking in and out assets because the user can be required to scan the barcode of the asset tag using the machine before they complete the transaction. In some embodiments, a control board within a locker can recognize when the device is plugged in and then it enables the door to be locked.

In some embodiments, the lockers may include wireless internet, plugs, Ethernet, and/or USB ports that allow assets and devices to be charged, configured for the user, or updated with software patches. In some embodiments, the lockers may be big enough to hold a large laptop, PC bundles, mailed packages or anything smaller. In some embodiments, the IT resources may receive a ticket notification that the broken equipment needs to be repaired and they can work on it based on their other priorities without needing to interact with the employee. In a remote office where there are no IT resources, for example, a courier can pick up and mail broken devices to a central IT helpdesk. In some embodiments, the solution may provide a complete automation of the workflow for IT helpdesk and provides the physical interaction that the Enterprise Service Management system cannot do.

In some embodiments, a check-in & check-out process is disclosed for devices used by shift workers. Some embodiments allow for automated unmanned check-in, charging, secure, and/or check-out of any hand-held peripheral devices and/or assets. Some embodiments may provide positive control for checking in assets because the control board on the lockers can recognize when the device is plugged in and then it enables the door to be locked. In some embodiments, users can be identified by swiping their ID badge or logging into the service management system using the kiosk. In some embodiments, the lockers may have plugs or USB ports that allow assets and/or devices to be charged or configured or software updated. With the advancement of the Internet of Things, many jobs may require handheld devices for their shiftwork. These devices can include, but are not limited to smartphones, tablet PCs, barcode readers, scanners, and may also include non-electronic equipment like safety equipment, investigation evidence, etc. Some embodiments may be integrated with a Service Management asset tracking database, the configuration management database or a ticket tracking database.

Some embodiments may include IT peripheral and consumables dispensing. Some embodiments may provide automatic instant gratification and access to devices and equipment that employees need for their job. Employees can browse a catalog of peripherals and devices that are available in the automated stockroom either remotely from their computer or mobile phone, or at the machine on the kiosk. Once a user selects what they want, a helpdesk ticket may be created in the service management system and/or the employee is told where to pick it up from the closest dispensing machine that has the equipment. In some embodiments, if the device is not in stock in any machine nearby, the user may receive a notification email or text from the service management system when the requested product is in stock. In some embodiments, if the employee requires authorization to receive a given product from the catalog, then the Enterprise Service Management system may execute an approval workflow for the process before dispensing the product. Some embodiments may track what is on inventory in the machine and can be configured to automatically trigger a new Purchase Order approval workflow once the limit threshold of a product has been reached and/or a new product needs to be ordered; this may enable just in time inventory. The convenience of this solution, for example, may facilitate all purchases to be funneled through corporate negotiated suppliers, thus providing the potential for volume discounts.

Some embodiments include a voice interactive help desk ticket support on a kiosk connected to the service management system: When a help desk ticket requires more than just information that can be displayed on a screen or printed on a printer; some embodiments may provide the options and/or fixes that may be required to resolve the ticket rather than just logging it for later. By having a physical presence in offices where employees can get support, employees may have a better experience.

Some embodiments may enable employees to enter help desk tickets and provide their problem information. By swiping an ID badge, a kiosk can identify the employee and populate many of the required fields for a ticket. In some embodiments, the Service Management system may know what assets the employee has assigned to them and/or can identify likely issues and make the interaction more efficient. In some embodiments, the employee can also verbally provide information about the helpdesk ticket and verbally navigate scripts that are preprogrammed for the helpdesk to enter information and troubleshoot a problem. Sometimes an employee just wants someone to tell their problem to and this solution can also capture the narrative of the problem, log it for future resolution and provide possible options and information by accessing the Service Management VR knowledgebase.

In some embodiments, an IT resource may receive a notification that broken equipment needs to be repaired. The IT resource may work on it based on their other priorities without needing to interact with the employee. In a remote office where there are no IT resources a courier can be used to pick up and mail broken devices to a central IT helpdesk. Some embodiments may provide a complete automation of the workflow for IT helpdesk and provides the physical interaction that the Enterprise Service Management system cannot do.

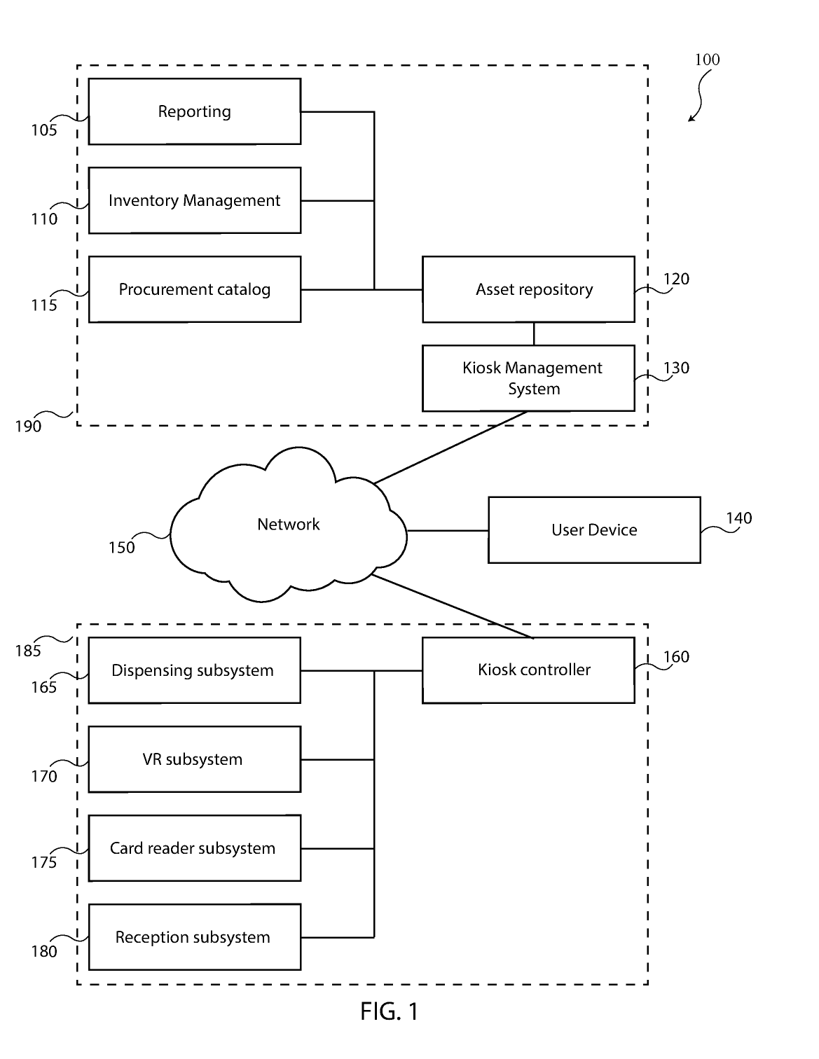

FIG. 1 is a block diagram of an automated stockroom system 100 according to some embodiments. The automated stockroom system 100 may include an automated stockroom kiosk 185 and/or a kiosk management system 190 in communication via network 150 such as, for example, the Internet.

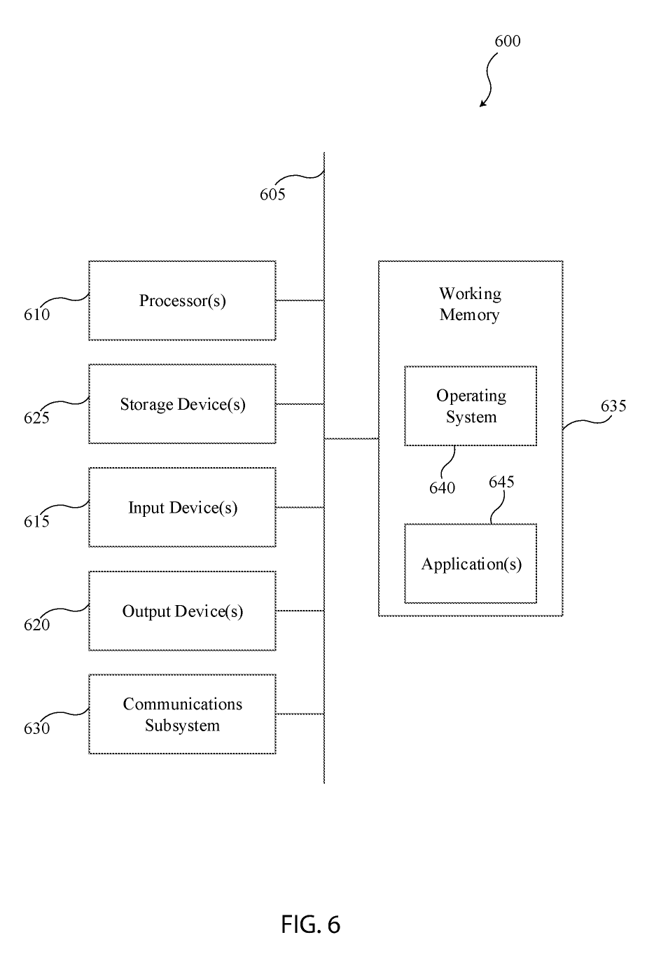

In some embodiments, the kiosk management system 190 may include one or more servers located in a single location and/or geographically distributed and connected through the network 150. In some embodiments, the server or each server of the kiosk management system 190 may include some or all the components of the computational system 600, shown in FIG. 6.

In some embodiments, the kiosk management system 190 may include a service management system 130.

In some embodiments, the asset repository 120 may coordinate assets among the procurement catalog 115 and/or the inventory management system 110 among any number of deployed kiosks.

In some embodiments, the procurement catalog 115 may include a list of assets that are not currently available within a kiosk but may be procured in the future. For example, users/employees may select such asset via an external user device 140. The selected asset can be procured and delivered to a given kiosk 185. An email or message can be sent to the user indicating that the asset is available at the given kiosk 185. The user may then retrieve the asset from the kiosk. For instance, once the user is authenticated at the kiosk (e.g., see blocks 310 and/or 510 of processes 300, 400, 500, and/or 700) the kiosk may ask if the user would like to retrieve the asset.

In some embodiments, the inventory management system 110 may include a list of the assets available to be dispensed within each kiosk. The inventory management system 110 may include, for example, a database that correlates available assets with items such as kiosk locations, distance between kiosks, number of each available asset within each kiosk, types of employees/users that can procure a given asset, etc.

In some embodiments, the reporting system 105 may provide reports regarding the inventory found within one or more kiosks.

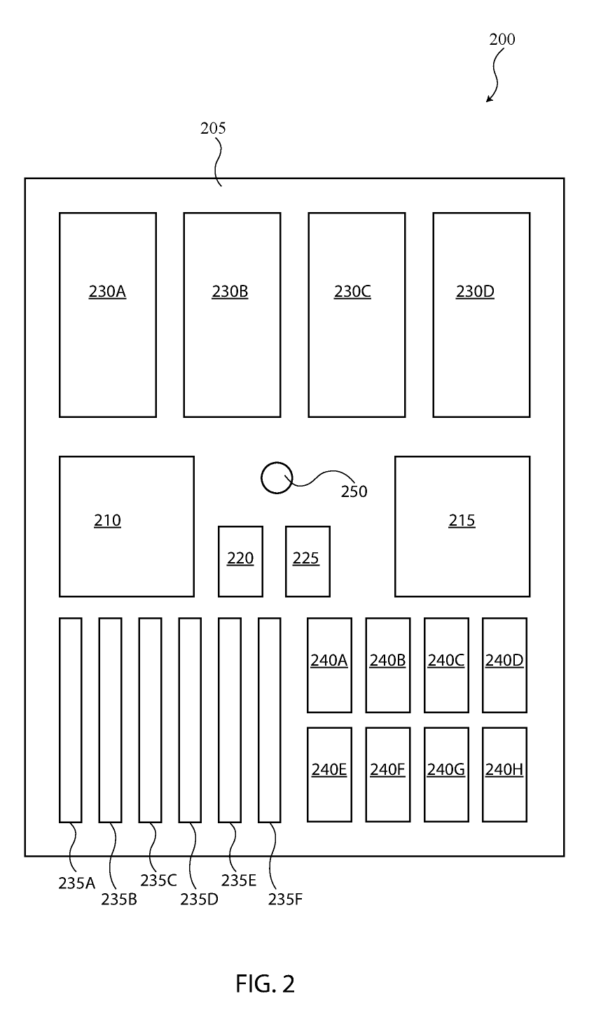

In some embodiments, the automated stockroom kiosk 185 may include the automated stockroom kiosk 200 shown in FIG. 2. In some embodiments, the automated stockroom kiosk 185 may include a kiosk controller 160 that is in communication with a dispensing subsystem 165, an virtual VR subsystem 170, a card reader subsystem 175, and/or a reception subsystem 180. In some embodiments, the kiosk controller 160 may include some or all the components of the computational system 600, shown in FIG. 6.

In some embodiments, the kiosk controller 160 may be in communication with the kiosk management system 190 via the network 150. The network 150 may include the Internet and/or any other communication network.

In some embodiments, the kiosk controller 160 may include a touch screen, a display, a keyboard, buttons, etc. that may be used to receive user input such as, for example, regarding a user's product selection.

In some embodiments, the dispensing subsystem 165 may store and/or dispense products stored within a kiosk. The dispensing subsystem 165 may include any number of mechanical and/or electrotechnical devices that may dispense products from the kiosk such as, for example, doors, lockers, locks, motors, corkscrews, conveyors, etc. In some embodiments, the dispensing subsystem 165 may dispense one or more products in response to a command or message received by the kiosk controller 160.

In some embodiments, the card reader subsystem 175 may include an RFID reader, a magnetic stripe reader, a barcode reader, NFC reader, etc. In some embodiments, the card reader subsystem 175 may read an employee ID card (or employee ID badge) and return an employee ID, an employee name, an employee title, an employee position, or other employee information, etc.

In some embodiments, the card reader subsystem 175 may communicate with an employee database (e.g., an HR server). For example, the card reader subsystem 175 may communicate data retrieved from the employee ID to the employee database. The employee database may provide the employee name and/or the products that may be dispensed to the employee by the automated stockroom kiosk 185.

In some embodiments, the card reader subsystem 175 may read a code (e.g., barcode, NFC code, RFID code, QR code, etc.) from a product that has been dispensed by the dispensing subsystem 165 and/or received by the reception subsystem 180. The card reader subsystem 175 may then communicate the code received by the reception subsystem 175 to the kiosk controller 160.

In some embodiments, the reception subsystem 180 may include any mechanical and/or electromechanical devices that can securely receive an item from a user such as, for example, doors, lockers, locks, motors, conveyers, electromechanical locks, etc.

In some embodiments, the kiosk controller 160 and/or the kiosk management system 190 may perform all or some of the blocks of processes 300, 400, 500, and/or 700.

In some embodiments, the dispensing subsystem 165 and/or the reception subsystem 180 may include multiple sets of lockers. In some embodiments, each locker of the plurality of lockers may have any number of ports such as, for example, internet connector, power receptacles, plugs, wireless charging pads, USB ports, Firewire connector, etc. In some embodiments, these ports may be used to allow assets to be charged, configured, configured for a specific user, cleaned, swiped, updated with new software, update existing software, apply a software patch, etc. In some embodiments, the lockers may be big enough to hold a large laptop, PC bundles, mailed packages or anything smaller. In some embodiments, various sized lockers may be included.

FIG. 2 is a block diagram of a kiosk 200 according to some embodiments. The block diagram, for example, indicates the elements interfaced by a user. The kiosk 200 may include a kiosk body 205 that may include various components including metal, plastic, and/or glass. The kiosk body 205 may enclose various electronics and/or communication devices and/or other components of the kiosk 200.

In some embodiments, the kiosk 205 may include a user interface 210. The user interface 210 may include a display, keyboard, buttons, keypad, etc. In some embodiments, the user interface 210 may include a touchscreen display.

In some embodiments, the user interface 210 may provide any number of interactive options for a user to interface with the kiosk 205 and/or the automated stockroom system 100. In some embodiments, the user interface 210 may present a catalog of popular items to a user; allow a user to browse a machine catalog; present a listing of available hardware assets (e.g., laptops, phones, tablets, etc.), peripherals (e.g., re-usable assets such as memory sticks, a mouse, cables, etc.), consumables (e.g., non-reusable assets such as printer cartridges, office supplies, etc.), shift assigned items for a given user (e.g., a catalog of 1 or 2 items for day shift), and/or user specific assigned assets (may require a login), user requested assets (may require a login); repair and/or loaner support information and/or options (e.g., links to catalog with selected product to turn in loaner); and/or order and/or procurement (e.g., opens company catalog for order and later pickup from a kiosk locker).

In some embodiments, the kiosk 205 may include a card reader 220 and/or a barcode reader 225. The card reader 220 may include an RFID reader, NFC reader, magnetic stripe reader, etc. The card reader 220 may be used, for example, to receive an employee identification information. The barcode reader 225 may include a camera that can be used to read and/or interpret a barcode and/or a QR code. In some embodiments, the card reader 220 and/or a barcode reader 225 may be combined within a single device. In some embodiments, the card reader subsystem may include the card reader 220 and/or the barcode reader 225.

In some embodiments, the kiosk 205 may include a digital camera 250. The digital camera 250 may record user interactions and store video and/or images of users retrieving devices from and/or depositing devices with the kiosk. These videos and/or images may be stored within memory at the kiosk and/or communicated to the kiosk management system 190 for storage.

In some embodiments, the kiosk 205 may include a VR subsystem 215. In some embodiments, the virtual VR subsystem 170 may include the VR subsystem 215. The VR subsystem 215, for example, may interact with a user within the scope of the solution and within the knowledge of data available in the kiosk management system 190. The VR subsystem 215 may visually demonstrate emotional reactions to the information that the user is communicating verbally. For example, if a user is frustrated, then the virtual personality can demonstrate compassion in their facial reaction. The VR subsystem 215, for example, may have access to user/employee information in the kiosk management system 190. The VR subsystem 215, for example, may provide as complete of an experience as a helpdesk person sitting on the other side of a phone, and/or can deliver instant gratification through dispensing a gift or taking the broken equipment and providing a loaner. The VR subsystem 215, for example, may be used to interact with any employee system for employee transactions including finance, HR, sales, etc. systems. In some embodiments, the VR subsystem 215 may use a voicebot and/or a visual personality to provide a realistic experience.

In some embodiments, the VR subsystem 215 may include a camera, a display, and/or a communication interface (e.g., an internet adopter) that allows a user to communicate with a live person to receive instructions, help, guidance, assistance, etc. regarding using the kiosk 205.

In some embodiments, the kiosk 205 may include any number of lockers. In this example, four large lockers 230A, 230B, 230C, and 23D are shown. These lockers may be used to dispense larger items such as computers, peripherals, equipment, etc. Six skinny lockers 235A, 235B, 235C, 235D, 235E, 235F, and 235F are included in this example. These skinny lockers, for example, may be used to dispense and/or receive tablets and/or laptops. Eight small lockers 240A, 240B, 240C, 240D, 240E, 240F, 240G, and 240H are shown. These small lockers, for example, may be used to dispense and/or receive phones, peripherals, handheld equipment, accessories, ink cartridges, batteries, cables, cords, memory devices, cameras, etc.

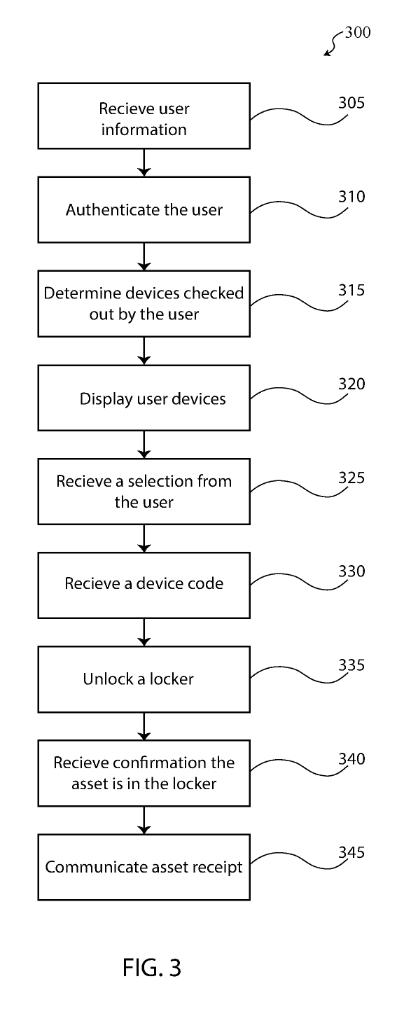

FIG. 3 is a flowchart of a process 300 for receiving an asset according to some embodiments. In some embodiments, the process 300 may include additional blocks. In some embodiments, the process 300 may not include all the blocks shown. In some embodiments, the blocks shown in the process 300 may occur in a different order.

The process 300 starts at block 305. At block 305 user information may be received at the kiosk controller 160. The user information may be received in any numbers of ways and may include a combination of techniques. The user information may include, for example, employee ID, employee name, employee user name, email, phone number, password, pin, etc. For example, the user information may be received via an employee ID card (or a code displayed on the screen of a user's phone) that is scanned by the card reader subsystem 175. As another example, the user may enter user information via the user interface 210. As another example, a camera may capture the image of the user and identify the user via facial recognition techniques and/or comparison of the face and/or facial features with faces and/or facial profiles of known users. As yet another example, a microphone may capture the voice of the user (e.g., the user stating their name) and determining the name of the user based on audio recognition techniques and/or comparison of the audio and/or audio features with audio and/or audio profiles of known users.

At block 310 the user may be authenticated. For example, the kiosk controller 160 may communicate the user information to the service management system 130 and/or another server (e.g., an HR server or database) that can be used to authenticate the user. In some embodiments, a return message may indicate one or more of the following: authentication affirmation, information about the user's access, information about the user's approval for receiving various available assets, information about the assets in possession by the user, open tickets of the user from previous events, etc.

At block 315 the devices in possession of (or checked out by) the user may be determined. This may be determined, for example, from the authentication message. As another example, this may be determined by requesting information about the devices in possession by the user via the inventory management subsystem 110 (or the asset repository). As another example, the kiosk controller 160 may include a database that includes a listing of devices in possession of various users.

At block 320 the various user devices in possession may be displayed on the user interface 210. For example, if the user has a mobile phone and a laptop, these assets may be displayed such as, for example, as icons, images, and/or text.

At block 325 the user may indicate which of the various user devices the user is returning. For example, the user display may include a touch screen and the user may select the item by touching it (or an icon or an image or text) on the touch screen. As another example, the display may indicate a number or a letter or a button that may be selected by the user to indicate which device is being returned.

In some embodiments, blocks 315, 320, and/or 325 may be skipped. For example, a user may have only a single device in their possession. In such a situation these blocks may be superfluous. As another example, the user may have previously indicated that they will be returning a specific device such as, for example, via a web interface, a mobile device app, or via conversation with an IT representative. The authentication response at block 310 may indicate the device that the user is returning. In some embodiments, a confirmation regarding the device may be displayed and/or confirmed by the user.

At block 330 a device code may be scanned via the card reader subsystem 175. For example, the device may include a bar code or a QR code (or any other code) that can be scanned by the card reader subsystem 175. The device code may be confirmed to correspond with the device indicated in block 325 as being returned by the user.

At block 335, if the device code received at block 330 is confirmed, then an empty locker may be opened. For example, the stockroom controller may keep a database of lockers that include device and/or that are empty. In some embodiments, the device code received at block 330 and/or information about the device may be retrieved from the service management system 130 and/or information stored at the kiosk controller 160 may indicate a size of the device being returned or indicate the appropriate locker size(s) that the device may fit within. In response, an empty locker with the proper size may be unlocked and/or opened. In some embodiments, the locker number may be indicated via the user interface 210. In some embodiments, a light may be turned on at or near the locker.

In some embodiments, instructions about placing the device within the locker may be displayed on the user interface 210.

At block 340 confirmation may be received that a device has been placed within the locker. For example, the locker door may provide a signal that it has been opened and/or closed. As another example, a weight sensor may indicate a device has been placed within the locker. As another example, a capacitive sensor may indicate a change in the capacitance within the locker. As another example, an optical sensor and/or camera may indicate a change within the locker. As another example, if the device has been plugged into a power receptacle or a USB connector then the power receptacle or USB connector may indicate a device has been connected.

The locker may then be closed and/or locked. In some embodiments, if the locker is not closed, the user interface may display a request to lock the locker and/or a sound may be transmitted asking the user to closer the locker.

In some embodiments, the user display may ask the user to indicate that they have placed the device within the locker.

At block 345 receipt of the device may be communicated to the service management system 130. In some embodiments, the inventory management system may be updated with information about receipt of the device.

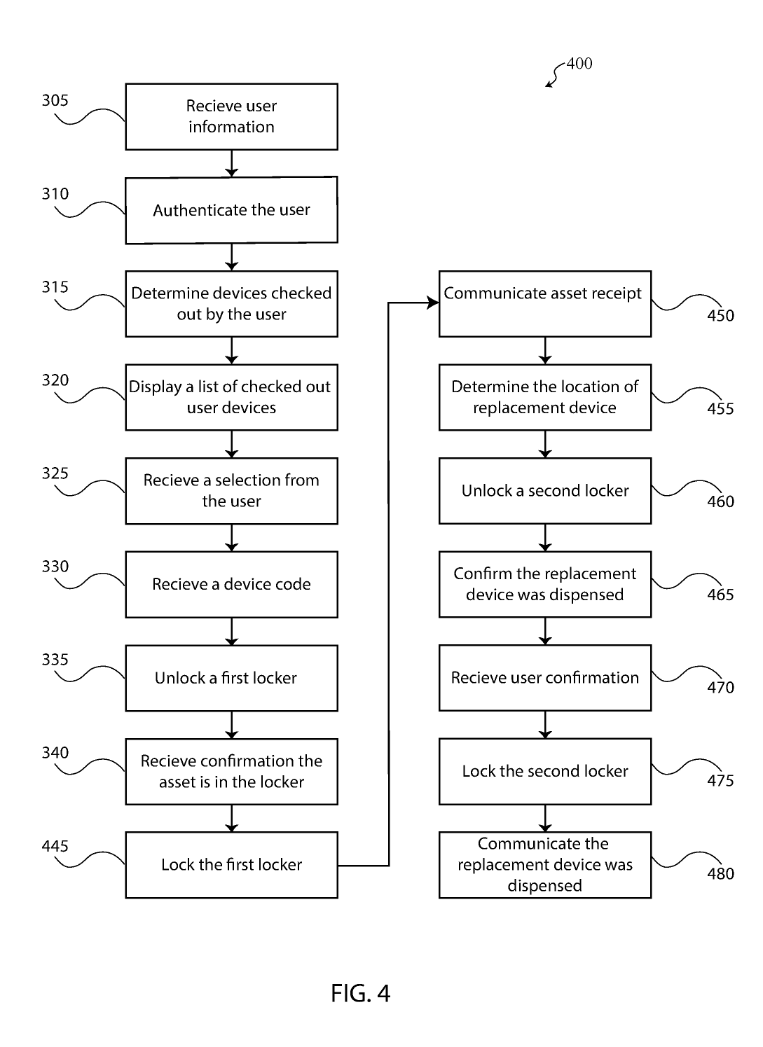

FIG. 4 is a flowchart of a process 400 for receiving an asset according to some embodiments. In some embodiments, the process 400 may include additional blocks. In some embodiments, the process 400 may not include all the blocks shown. In some embodiments, the blocks shown in the process 400 may occur in a different order.

Blocks 305, 310, 315, 320, 325, 330, and/or 340 may be similar as similarly labeled blocks of process 300 and as described above.

At block 435 in the process 400 a first locker is unlocked as described above in conjunction with block 335. At block 445 the first locker may be locked.

Block 450 may be similar to block 345 as described above.

At block 455 the location of a replacement device may be determined. A replacement device may be determined based on the user ID and/or the inventory available within the automated stockroom kiosk 185 and/or the type of device that was returned. Once the type of replacement device has been determined the locker location within the automated stockroom kiosk 185 may be determined such as, for example, based on a database of devices and locations held within the kiosk controller 160 and/or the inventory management subsystem 110.

In some embodiments, more than one replacement device may be available to the user. In some embodiments, a plurality of available replacement devices may be displayed on the user interface 210. The user may select a replacement device via the user interface 210. Then the location (e.g., a locker) of the selected replacement device may be determined.

In some embodiments, replacement assets that are not currently available within the kiosk 185 may be included within the display. For example, the kiosk controller 160 may receive information from the kiosk management system 130 regarding assets (or devices) that are not currently available within the kiosk 185 yet can be ordered through the kiosk and delivered to the kiosk at some future time. In some embodiments, replacement devices that are available may be labeled or color coded as being available and/or replacement devices that are unavailable may be labeled or color coded as being currently unavailable and/or labeled with a time when a given replacement devices may be available. If the user selects a replacement device that is not currently available within the kiosk, then process 400 may end.

In some embodiments, the kiosk controller 160 may determine a future time when an offered but unavailable replacement asset (or device) may be available within the kiosk 185. For example, the kiosk controller 160 may send a message to the kiosk management system 130 requesting information regarding assets (or devices) that can be delivered to the kiosk 185. In response, the kiosk management system 130 may determine replacement devices that may be delivered to the kiosk 185 by querying the procurement catalog 115 and noting which assets (or devices) are currently at the kiosk by referring to the inventory management subsystem 110. In some embodiments, the kiosk management system 130 may communicate assets that can be delivered in the future to the kiosk controller 160 and a date and/or time when the device may be available.

If the user selects an unavailable device from the user interface, the kiosk controller 160 may send a request to the kiosk management system 130 to have the unavailable device delivered to the kiosk. The kiosk controller 160 may communicate a future date and/or time when the unavailable device will be available to retrieve from the kiosk and/or the user may provide contact information. The unavailable device can be flagged for delivery to the kiosk 185 and/or flagged to be retrieved by the requesting user. In some embodiments, when the unavailable device is delivered and added to the dispensing subsystem 165 of the kiosk 185, the unavailable device can be reserved for the requesting user. For example, other user may not be able to procure the device such as, for example, for a period of time to allow the requesting user to retrieve the device. The requesting user may receive an email or text message indicating that the unavailable device is available to retrieve from the kiosk. In some embodiments, the email or text message, for example, may include a QR code that may be scanned by the card reader subsystem 175, card reader 220, or the digital camera 250. In response to reading the QR code, the process 400 may begin at block 460 and the locker where the unavailable device is stored may be opened. As another example, the user may swipe or scan their employee ID, and in response the process 400 may begin at block 460 and the locker where the unavailable device is stored may be opened.

At block 460 a locker with the replacement device may be opened such as, for example, the locker where a selected and/or available replacement device is stored may be opened. In some embodiments, the locker number may be indicated on the user interface 210. In some embodiments, a light may be turned on at or near the locker.

At block 465 a confirmation that the replacement device has been dispensed may be received at the kiosk controller 160. For example, the locker door may provide a signal that it has been opened and/or closed. As another example, a weight sensor may indicate a device has been removed from within the locker. As another example, a capacitive sensor may indicate a change in the capacitance within the locker. As another example, an optical sensor and/or camera may indicate a change within the locker. As another example, if the device had previously been plugged into a power receptacle or a USB connector then the power receptacle or USB connector may indicate a device has been disconnected.

At block 470 a user confirmation may be received. The user confirmation may, for example, include the user confirming via the user interface 210 that they have received the replacement device. The user, for example, may enter a code at the user interface. As another example, a code on the replacement device may be scanned by the card reader subsystem 175.

At block 475 the second locker may be locked.

At block 480 a message may be communicated that the replacement device has been dispensed. In some embodiments, this message may be sent from the kiosk controller 160 to the service management system 130.

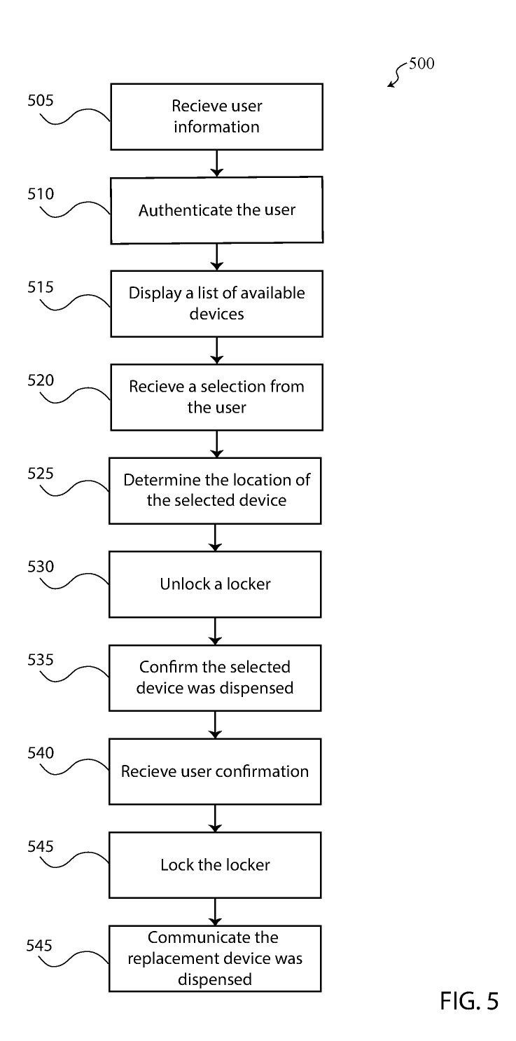

FIG. 5 is a flowchart of a process 500 for dispensing an asset according to some embodiments. In some embodiments, the process 500 may include additional blocks. In some embodiments, the process 500 may not include all the blocks shown. In some embodiments, the blocks shown in the process 500 may occur in a different order.

The process 500 starts at block 505. At block 505 user information may be received at the kiosk controller 160. The user information may be received in any numbers of ways and may include a combination of techniques. The user information may include, for example, employee ID, employee name, employee user name, email, phone number, password, pin, etc. For example, the user information may be received via an employee ID card (or a code displayed on the screen of a user's phone) that is scanned by the card reader subsystem 175. As another example, the user may enter user information via the user interface 210. As another example, a camera may capture the image of the user and identify the user via facial recognition techniques and/or comparison of the face and/or facial features with faces and/or facial profiles of known users. As yet another example, a microphone may capture the voice of the user (e.g., the user stating their name) and determining the name of the user based on audio recognition techniques and/or comparison of the audio and/or audio features with audio and/or audio profiles of known users.

At block 510 the user may be authenticated. For example, the kiosk controller 160 may communicate the user information to the service management system 130 and/or another server (e.g., an HR server or database) that can be used to authenticate the user. In some embodiments, a return message may indicate one or more of the following: authentication affirmation, information about the user's access, information about the user's approval for receiving various available assets, information about the assets in possession by the user, open tickets of the user from previous events, etc.

At block 515 a listing of assets (or devices) available to the user may be displayed on the user interface 210. In some embodiments, only devices available to the user may be displayed. For example, different users may be authorized to retrieve different devices. For example, users may be authorized to retrieve different devices based on job title, seniority, position, tasks, job requirements, bonuses, etc. In some embodiments, the various devices available to the user may be stored in the inventory management subsystem 110. In some embodiments, only devices available within the kiosk or within nearby kiosk may be displayed. In some embodiments, devices that can be delivered may also be displayed as discussed above.

At block 520 the user may indicate which of the various user devices the user would like to retrieve from the kiosk. For example, the user display may include a touch screen and the user may select the item by touching it (or an icon or an image or text) on the touch screen. As another example, the display may indicate a number or a letter or a button that may be selected by the user to indicate which device should be dispensed.

At block 525 the location of a selected device may be determined. A selected device may be determined based on the user ID and/or the inventory available within the automated stockroom kiosk 185 and/or the type of device that was returned. Once the type of selected device has been determined the locker location within the automated stockroom kiosk 185 may be determined such as, for example, based on a database of devices and locations held within the kiosk controller 160 and/or the inventory management subsystem 110.

At block 530 a locker with the selected device may be unlocked.

At block 535 a confirmation that the selected device has been dispensed may be received at the kiosk controller 160. For example, the locker door may provide a signal that it has been opened and/or closed. As another example, a weight sensor may indicate a device has been removed from within the locker. As another example, a capacitive sensor may indicate a change in the capacitance within the locker. As another example, an optical sensor and/or camera may indicate a change within the locker. As another example, if the device had previously been plugged into a power receptacle or a USB connector then the power receptacle or USB connector may indicate a device has been disconnected.

At block 540 a user confirmation may be received. The user confirmation may, for example, include the user confirming via the user interface 210 that they have received the selected device. The user, for example, may enter a code at the user interface. As another example, a code on the selected device may be scanned by the card reader subsystem 175.

At block 545 the locker may be locked.

At block 550 a message may be communicated that the selected device has been dispensed. In some embodiments, this message may be sent from the kiosk controller 160 to the service management system 130.

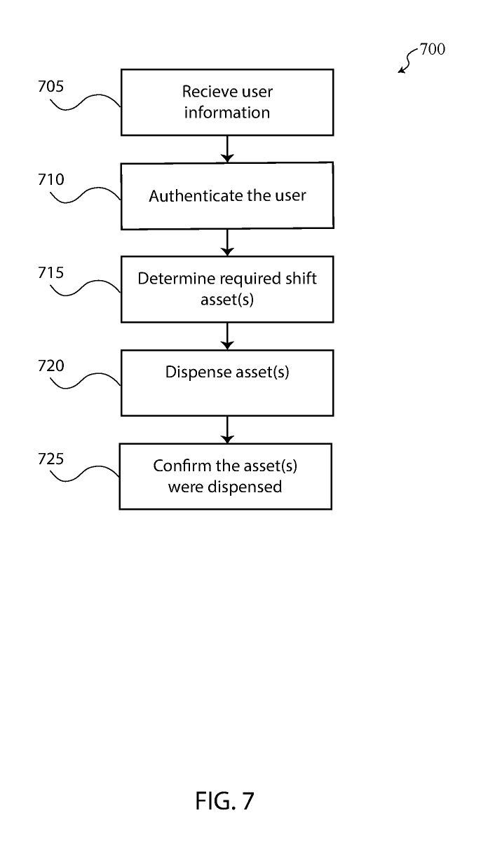

FIG. 7 is a flowchart of a process 700 for dispensing shift asset(s) according to some embodiments. In some embodiments, the process 700 may include additional blocks. In some embodiments, the process 700 may not include all the blocks shown. In some embodiments, the blocks shown in the process 500 may occur in a different order.

The process 700 starts at block 705. At block 705 user information may be received at the kiosk controller 160. The user information may be received in any numbers of ways and may include a combination of techniques. The user information may include, for example, employee ID, employee name, employee user name, email, phone number, password, pin, etc. For example, the user information may be received via an employee ID card (or a code displayed on the screen of a user's phone) that is scanned by the card reader subsystem 175. As another example, the user may enter user information via the user interface 210. As another example, a camera may capture the image of the user and identify the user via facial recognition techniques and/or comparison of the face and/or facial features with faces and/or facial profiles of known users. As yet another example, a microphone may capture the voice of the user (e.g., the user stating their name) and determining the name of the user based on audio recognition techniques and/or comparison of the audio and/or audio features with audio and/or audio profiles of known users.

At block 710 the user may be authenticated. For example, the kiosk controller 160 may communicate the user information to the service management system 130 and/or another server (e.g., an HR server or database) that can be used to authenticate the user. In some embodiments, a return message may indicate one or more of the following: authentication affirmation, information about the user's access, information about the user's approval for receiving various available assets, information about the assets in possession by the user, open tickets of the user from previous events, etc.

At block 715 the asset(s) required for the authenticated employee's shift may be determined. These items may be determined based on a database (e.g., a database stored at kiosk controller 160 and/or service management system 130) indicating which items are required for a given shift, a given position within a shift, a given employee, etc. In some embodiments, the required asset(s) may vary depending on the time of day, progress or lack of progress that occurred during a previous shift, employee training, employ certifications, etc.

At block 720 once the asset(s) have been determined these assets may be dispensed such as, for example, using the dispensing subsystem 165.

At block 725 a confirmation that the asset(s) were dispensed may be received at the kiosk controller 160. For example, a locker door may provide a signal that it has been opened and/or closed. As another example, a weight sensor may indicate a device has been removed from within a locker. As another example, a capacitive sensor may indicate a change in the capacitance within a locker. As another example, an optical sensor and/or camera may indicate a change within the locker. As another example, if the device had previously been plugged into a power receptacle or a USB connector then the power receptacle or USB connector may indicate a device has been disconnected. As another example, a camera may also be used to indicate that the asset(s) have been dispensed. As another example, the user may confirm receipt of the asset(s) via the user interface 210 such as, for example, by entering a code via the user interface. As another example, a code on the replacement device may be scanned or read by the card reader subsystem 175.

At the end of the user(s) shift the asset(s) may be returned, for example, via the process 300.

In some embodiments, a new kiosk may be commissioned and/or configured within the kiosk management system 190 this may include, for example, in or all of the following: configure the number and sizes of bins and/or lockers within a kiosk (In some embodiments, a kiosk can self-report from configuration); the asset(s) from the catalog may be selected as being held within the kiosk; the assets may be assigned to bins and/or lockers; catalog task requests may be created; the quantity of consumables to load and confirm; the load and count steps required; quantity of consumables loaded; scan the codes of the assets loaded within kiosk; set replenishment triggers for each asset; etc.

The computational system 600, shown in FIG. 6 can be used to perform any of the embodiments of the invention. For example, computational system 600 can be used to execute one or more of the processes 300, 400, 500, and/or 700. As another example, computational system 600 can be used perform any calculation, identification and/or determination described here. The computational system 600 includes hardware elements that can be electrically coupled via a bus 605 (or may otherwise be in communication, as appropriate). The hardware elements can include one or more processors 610, including without limitation one or more general-purpose processors and/or one or more special-purpose processors (such as digital signal processing chips, graphics acceleration chips, and/or the like); one or more input devices 615, which can include without limitation a mouse, a keyboard and/or the like; and one or more output devices 620, which can include without limitation a display device, a printer and/or the like.

The computational system 600 may further include (and/or be in communication with) one or more storage devices 625, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 600 might also include a communications subsystem 630, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 630 may permit data to be exchanged with a network (such as the network described below, to name one example), and/or any other devices described herein. In many embodiments, the computational system 600 will further include a working memory 635, which can include a RAM or ROM device, as described above.

The computational system 600 also can include software elements, shown as being currently located within the working memory 635, including an operating system 640 and/or other code, such as one or more application programs 645, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 625 described above.

In some cases, the storage medium might be incorporated within the computational system 600 or in communication with the computational system 600. In other embodiments, the storage medium might be separate from a computational system 600 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 600 and/or might take the form of source and/or installable code, which, upon compilation and/or installation on the computational system 600 (e.g., using any of a variety of generally available compilers, installation programs, compression/decompression utilities, etc.) then takes the form of executable code.

Unless otherwise specified, the term “substantially” means within 5% or 10% of the value referred to or within manufacturing tolerances. Unless otherwise specified, the term “about” means within 5% or 10% of the value referred to or within manufacturing tolerances.

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. An asset dispensing kiosk comprising:
a plurality of lockers having electromechanical locks;
a user interface;
a card reader configured to read employee ID cards; and
a kiosk controller communicatively coupled with the plurality of lockers, the user interface, and the card reader, the kiosk controller configured to:
receive an employee ID from an employee ID card associated with an employee via the card reader;
determine one or more approved assets held within one or more of the plurality of lockers that are available to be dispensed to the employee;
provide a listing of the one or more approved assets held within the plurality of lockers via the user interface;
receive an indication from a user via the user interface specifying a specific asset of the one or more approved assets;
determine a specific locker of the plurality of lockers where the specific asset is located; and
dispense the specific asset stored within specific locker by unlocking the one or more electromechanical lock associated with the specific locker.

2. The asset dispensing kiosk according to claim 1, wherein each of the plurality of lockers include a USB connection.

3. The asset dispensing kiosk according to claim 1, wherein the kiosk controller is further configured to authenticate the employee associated with the employee Id.

4. The asset dispensing kiosk according to claim 1, further comprising a code reader configured to read visual code displayed on an asset, wherein the kiosk controller is further configured to:
read a code on the specific asset; and
confirm that the specific asset was the proper asset to be dispensed.

5. The asset dispensing kiosk according to claim 1, further comprising a code reader configured to read visual code displayed on an asset, wherein the kiosk controller is further configured to:
read a code on the specific asset; and
record in a database that the employee associated with the employee ID received the specific asset including the code on the specific asset and the employee ID.

6. The asset dispensing kiosk according to claim 1, further comprising a communication interface, wherein the kiosk controller is further configured to:
send the employee ID to a remote server via the communication interface; and
receive a listing of approved one or more approved assets from the remote server.

7. The asset dispensing kiosk according to claim 1, wherein each of the plurality of lockers includes a sensor that can detect the presence or absence of an asset within the locker, and wherein the kiosk controller can receive a signal from each sensor indicating whether an asset is located within corresponding locker.

8. The asset dispensing kiosk according to claim 1, further comprising a digital camera that records an interaction with a user.

9. The asset dispensing kiosk according to claim 1, further comprising a digital camera, wherein the kiosk controller is further configured to:
receive a digital image from the digital camera; and
perform facial recognition on the digital image.

10. The asset dispensing kiosk according to claim 1, further comprising a VR interface that communicates with a user.

11. A method for operating an asset dispensing kiosk comprising:
receiving an employee ID from an employee ID card associated with an employee, the employee ID being received via a card reader;
determining one or more approved assets held within one or more of a plurality of lockers associated with a kiosk that are available to be dispensed to the employee;
providing a listing of the one or more approved assets held within the plurality of lockers via a user interface;
receiving an indication from a user via the user interface specifying a specific asset of the one or more approved assets;
determining a specific locker of the plurality of lockers where the specific asset is located; and
dispensing the specific asset stored within specific locker by unlocking the specific locker.

12. The method according to claim 11, further comprising authenticating the employee associated with the employee Id.

13. The method according to claim 11, further comprising:
reading a code on the specific asset after the asset has been dispensed using a code reader; and
confirming that the specific asset was the proper asset to be dispensed

14. The method according to claim 11, further comprising:
sending the employee ID to a remote server via a communication interface; and
receiving a listing of approved one or more approved assets from the remote server

15. The method according to claim 11, further comprising
reading a code on the specific asset after the asset has been dispensed using a code reader; and
recording in a database that the employee associated with the employee ID received the specific asset including the code on the specific asset and the employee ID.

16. An asset dispensing kiosk comprising:
a dispensing subsystem;
a user interface;
a card reader configured to read user ID cards;
a communication interface; and
a kiosk controller communicatively coupled with the dispensing subsystem, the user interface, the communication interface, and the card reader, the kiosk controller configured to:
receive an user ID from an user ID card associated with an user via the card reader;
determine one or more approved assets that are available to be requested by the user;
provide a listing of the one or more approved assets to the user via the user interface;
receive an indication from a user via the user interface specifying a specific asset of the one or more approved assets;
determine whether the specific asset is available to be dispensed by the dispensing subsystem; and
in the event the specific asset is not available to be dispensed by the dispensing subsystem, send a request to a cloud server requesting delivery of the specific asset.

17. The asset dispensing kiosk according to claim 16, wherein the kiosk controller is further configured to: in the event the specific asset is available to be dispensed by the dispensing subsystem, dispense the specific asset via the dispensing subsystem.

18. The asset dispensing kiosk according to claim 16, wherein the kiosk controller is further configured to:
receive an indication that the specific asset has been loaded within the dispensing subsystem;
receive an indication user interface and/or the card reader that the user is ready to retrieve the specific asset; and
dispense the specific asset from the dispensing subsystem.

19. The asset dispensing kiosk according to claim 16, wherein the dispensing subsystem comprises one or more lockers that include a USB connector.

20. The asset dispensing kiosk according to claim 16, further comprising a code reader configured to read visual code displayed on an asset, wherein the kiosk controller is further configured to:
read a code on the specific asset; and
confirm that the specific asset was the proper asset to be dispensed.
